(19) United States
(12) Patent Application Publication
(10) Pub. No.: US 2013/0158689 A1
(43) Pub. Date: Jun. 20, 2013

(54) TRIAGE SYSTEM THAT MEASURES IN REAL-TIME THE DEGREE OF REHABILITATION SUCCESS

(71) Applicants: Samantha Kurtz, Largo, FL (US); Michael Davis, Mansfield, OH (US); H. Robert Monsky, Ponte Vedra Beach, FL (US)

(72) Inventors: Samantha Kurtz, Largo, FL (US); Michael Davis, Mansfield, OH (US); H. Robert Monsky, Ponte Vedra Beach, FL (US)

(21) Appl. No.: 13/716,599

(22) Filed: Dec. 17, 2012

Related U.S. Application Data
(60) Provisional application No. 61/576,744, filed on Dec. 16, 2011.

(51) Int. Cl. G06F 17/00

(52) U.S. Cl. CPC G06F 17/00
USPC 700/92

(57) ABSTRACT

A system for triaging rehabilitation of a person includes an expert system, at least one memory, and a human interface. The expert system includes a processor for executing instructions to calculate a personal achievement score (PAS) indicative of progress toward rehabilitation. The PAS is a single number. The at least one memory is in communication with the processor of the expert system. The at least one memory includes at least one database containing a plurality of data sets relating to the rehabilitation of the person. Each of the plurality of data sets is accorded a numerical value indicative of the person's progress toward the rehabilitation. The numerical values are used by the expert system to calculate the PAS. The at least one human interface is in communication with the processor and the at least one memory, and permits the person to view the PAS in a continual and real-time manner.

### CROSS-REFERENCE TO RELATED APPLICATIONS

This application claims the benefit of U.S. Provisional Application No. 61/576,744, filed on Dec. 16, 2011. The entire disclosure of the above application is hereby incorporated herein by reference.

### FIELD OF THE INVENTION

The present invention relates to public and private institutions and organizations involved with offender rehabilitation. More specifically, it is a triage system which produces a real time measurement of an offender's rehabilitative achievement that can serve to unify, support, and improve the rehabilitative efforts of offenders and their intervention providers for the ultimate purpose of reducing recidivism.

### BACKGROUND OF THE INVENTION

An “offender” is defined herein as a person, juvenile or adult, who currently has, or may have had in the past, some form of criminal justice supervision which would include, but not necessarily be limited to, probation, parole, incarceration, or community service. If the offender is currently not incarcerated, but may still be under judicial supervision (e.g., probation or parole), the offender may also be known as an ex-offender, and can also be someone who has been completely released from custody/supervision.

Intervention providers are those institutions, public and private, and organizations, for profit, non-profit, and not for profit, attempting to help offenders rehabilitate through the provision of a myriad of services.

Society has one primary concern when it comes to an offender: how do you take someone who has proven they are willing to harm society and transform them into someone who is willing to embrace society instead? The answer to that question lies in successful rehabilitation, which is assumed to further lead to the eventual successful reintegration of the offender into society.

To date, rehabilitative efforts directed toward offenders in the United States of America have failed, at great expense to public safety and fiscal budgets. Current research indicates 7 million people in the next decade will be incarcerated. 700,000 are presently being released annually from our Federal/State prisons. When local county/municipal figures are added into the mix, 7.2 million adults (representing 3.2% of the adult population) will be involved in some level of incarceration in any given year. Additional Bureau of Justice statistics indicate that both the rates of incarceration and recidivism have steadily risen during the past decade when corresponding crime rates have fallen.

Although disturbing, the persistently escalating recidivism numbers are not surprising when considering the body of corrections research over the past 50 years that has been dedicated to studying the, efficacy of offender rehabilitation. That research has unequivocally arrived at one inescapable conclusion: a truly rehabilitative era in American corrections has yet to exist.

Nowhere is that conclusion more apparent than when one compares American rates of recidivism to those of other countries. Specifically, many countries which are often referred to as “Social Democracies” (Britain, Canada, Australia, New Zealand, and Israel), show recidivism rates on average of only 25% ten years post-incarceration. This is in contrast to the 80% rate currently calculated in the United States.

Those countries reporting enviably low recidivism rates have all embraced a typical medically-inspired model of rehabilitation (generally referred to as RNR which stands for Risk-Need-Responsivity). The RNR approach defines rehabilitation as the use of externally/internally available transitional resources which can be used to relearn or learn social functioning, basic life skills, conventional behavioral norms, and to regain or gain equilibrium and well-being. This approach stresses: 1) the accurate assessment and prioritized delineation of individual needs/deficits; 2) the development of a unified and holistic plan for rehabilitation of those deficits (addressing coexisting multiple deficit areas such as substance abuse, mental health, physical health, education, employment, family functioning, etc.); and 3) matching the identified deficits with available rehabilitation sources that have the greatest likelihood of rendering a positive rehabilitative effect.

The success of the rehabilitative approach in terms of reducing recidivism has not been ignored by major institutions involved in establishing corrections policy. Most especially, the Department of Justice (DOJ) has placed increasing emphasis on the inclusion of RNR practices as the preferred approach for organizations which intend to offer offender rehabilitative services. However, in their published organizational guidelines for community corrections they clearly state that the biggest challenge in adopting better offender interventions isn't in identifying the interventions which are most effective so much as in defining the change necessary in existing community organizational infrastructures to appropriately support proven evidence-based rehabilitation practices.

That fact was highlighted in the DOJ's recent final evaluation report of the Second Chance Act (the “Act”). The Act was intended to encourage correctional, community, public health, and social service providers to collaborate in the development of a reentry strategic plan which would measurably prove a 50% reduction in recidivism over five years. Evaluation data showed that even though the grantees of the Act were able to successfully develop inter-organizational partnerships, those associations did not result in any form of joint planning or process implementation, thereby negating the seamless delivery of the multiple levels of service delivery necessary for full and successful offender rehabilitation.

This identified absence of a workable organizational platform between offender intervention providers has been attempted to be addressed by several companies that have provided a unified reporting system of offender service/treatment data. Operationally, those efforts have been confined to tracking only those offenders who are judicially supervised after release. This constraint leaves the majority of the offender population (who do not have probation/parole requirements, but who still require coordination of extensive rehabilitation services in order to avoid recidivism) to their own devices in trying to navigate continuity of care in a byzantine sea of intervention providers.

Offenders are so labeled for life, which means that they, similar to alcoholics, will remain forever at risk for returning to former coping mechanisms to deal with exceptionally challenging life circumstances. Those challenges do not end when probation/parole requirements are met, and in fact may feel even more unmanageable without the networking/service support supervision provides.

Hence, even though collaborative reporting efforts have been in operation for many years, an appreciable reduction in recidivism has yet to be shown as a result of their efforts. This type of purely “actuarial” service provision reporting was destined to fall short. As evidenced by the findings of the Act, the problem in coordination of service is not that providers are incapable of communicating with one another, but that they cannot find a way of sharing a unified approach to rehabilitation functions. Differing capacities, treatment philosophies, and stakeholder obligations can easily interfere with taking a cohesive approach to offender rehabilitation. For example, in the critical area of accurate offender deficit assessment, there is little to no consensus regarding the coordinated use of available tools that have been standardized with an offender population. Instead intervention providers often use diverse tools which derive different results, thereby making it virtually impossible to measure overall offender rehabilitative success or regression.

Furthermore, the few programs that help probation/parole officers administer an offender's re-entry plan or track an offender's attendance at rehabilitation programs are unable to identify if any presented rehabilitative training attended by the offender has also been internalized and systematically applied. As previously stated, the goal of any rehabilitative effort is the eventual reintegration of the “participant” back into a state of equilibrium and well-being. Offender rehabilitation is, by its very nature, a lengthy process which must be negotiated in order to readjust to society. The course is further complicated by the fact that extensive former deficits are exacerbated (and additional deficits inculcated) as an automatic by-product of prolonged incarceration or repeated criminal involvement. As such, the successful culmination of an offender's rehabilitation—reintegration—will only be achieved through coordinated and continuous interaction between correctional authorities, treatment/service providers, and the returning offender, with the individual's family and community connections providing ongoing support/reinforcement of rehabilitative efforts.

The RNR rehabilitative measured outcomes are clear: reduced recidivism is a function of increased reintegration. Only a holistic, broad-based multi-systemic approach to rehabilitation will be effective in achieving offender pro-social reintegration into society due to the extensive range of deficits they automatically possess. Unless a system is capable of achieving the triage of a multiplicity of treatment/service providers that possess a diversity of core competencies, and which is solely dedicated to the entire and complex rehabilitation of the offender, the goal of reduced recidivism through increased reintegration will regrettably continue to remain unrealized.

There is a continuing need for a triage system and method for measuring in real-time the degree of rehabilitation success in a variety of rehabilitation settings, including penal, medical, psychological, and educational systems. Desirably, the triage system and method is particularly effective in increasing compliance in rehabilitation activities, thereby better insuring rehabilitation success

### SUMMARY OF THE INVENTION

In concordance with the instant disclosure, a system and method for measuring in real-time the degree of rehabilitation success in a variety of rehabilitation systems, including penal, medical, psychological, and educational systems, and which is particularly effective in increasing compliance in rehabilitation activities, thereby better insuring rehabilitation success, is surprisingly discovered.

In view of the foregoing, the present disclosure establishes a triage system that utilizes a mathematically calculated real time measurement of an offender's degree of rehabilitation to negotiate the coordination of multi-systemic rehabilitation efforts. It allows individual intervention providers to concentrate on improving their specific rehabilitative missions while simultaneously maintaining a holistic synchronization of interventions necessary to complete to achieve successful offender rehabilitation. When fully implemented, the system may be utilized as a safety measurement for the public, a scorecard for intervention providers, and proof of positive pro-social reintegration for the offender to provide to potential employers, judicial supervisors, etc.

The system compiles quantitative and qualitative data as both a threshold and ongoing measurement of rehabilitative functions, which have been research validated to reduce recidivism. It provides a full assessment battery, standardized with an offender population, which can be used by intervention providers to help develop prioritized individual offender rehabilitation plans. It also matches the identified specific set of offender rehabilitative needs to intervention provider capacities that will best insure successful rehabilitation outcomes.

The system and method is designed as well to perform triage functions over the extended period of time higher-risk offenders require to achieve full rehabilitation through the means of direct contact, mathematical monitoring and tracking, and statistical identification of rehabilitative progressive/regressive behavioral trends. Exception reporting through the Expert System will allow for adjustments in planning, and/or intervention provision. The system therefore will provide a platform for continuous improvement by way of two-way reporting processes between offenders and intervention providers.

The system and method of the disclosure is constructed to be utilized by both judicially supervised (meeting probation/parole requirements) offenders and non-supervised ex-offenders. The computer methodology and Expert System software will not only measure an offender's attendance during rehabilitation, but also whether the programming was internalized and ultimately applied. The scoring system's capability of combining standardized assessment, behavioral measurement, and triage processes allows for an offender's ongoing needs assessment and support during their entire course of rehabilitation to eventual reintegration.

In summary, the system answers the questions: 1) how rehabilitated is the offender at any given point in time; 2) what is their current risk of recidivating; and 3) what—if any—necessary steps are they presently taking to address those situations?

In one embodiment, a system for triaging rehabilitation of a person includes an expert system, at least one memory, and at least one human interface. The expert system including a processor for executing an instruction set for calculating a personal achievement score (PAS). The PAS is indicative of progress toward rehabilitation. Being indicative of progress toward rehabilitation, it should be understood that the PAS can also provide a baseline deficits measure, and therefore a starting, baseline, screening and assessment point, as well as an indicator of ongoing personal achievement progress. The PAS is a single number. The at least one memory is in communication with the processor of the expert system. The at least one memory includes at least one database containing a plurality of data sets. The data sets each relate to the rehabilitation of the person. Each of the plurality of data sets is accorded a numerical value indicative of the person's progress toward rehabilitation. The numerical values are then used by the expert system to calculate the PAS. The at least one human interface is in communication with the processor and the at least one memory. The human interface permits the person to view the PAS in a real-time manner and/or on a real-time basis.

The at least one database may include, but is not necessarily limited to, an assessment database, a contact database, and a registration database. The assessment database may include historical data, assessment data, behavioral data, performance data, observational data, and self-reported data. Each of the historical data, assessment data, behavioral data, performance data, observational data, and self-reported data may be used to calculate the PAS. Current research will be part of this database against which the other six sources of data will be weighed. Also there will be a rehabilitation plan database from which the plans will be generated once assessment weighted outcomes have been derived.

The processor of the expert system may further execute instructions for generating a trend score, a risk score, and a reliability score. The trend score is a continuous measure of rehabilitation efforts over a time period relative to a baseline PAS initially calculated for the person. The risk score is a continuous measure of rehabilitative needs on the part of the person plotted in percentile ranking format. The risk score is derived from the PAS of the person relative to the normal PAS distribution for a population of persons stored in the at least one memory. The reliability score is a continuous measure of the reliability of the PAS at any given time based on current level of collected data.

The system may further include a triage center computer in communication with the at least one memory via a web server. The triage center assigns the numerical value to the at least one of the plurality of data sets relating to rehabilitation of the person.

The at least one memory may further include an audio database in communication with the triage center. All audio contacts between the triage center and the person, and all audio contacts between the triage center and an intervention provider may be recorded and stored in the audio database. In particular examples, the audio database is part of the contact database. It should also be appreciated that video data may further be recorded and stored in the audio database, and that that the audio database is not necessarily limited to storage of just audio data.

The at least one human interface may be in communication with the at least one memory via a web server. The at least one human interface provides secure access to the PAS by at least one of an intervention provider and the person. In particular examples, the human interface is a dashboard on a visual display, for example, a computer monitor, a tablet monitor, a mobile phone, and the like. In certain cases, due to the highly sensitive nature of the data being shared, the human interface has security features such as usernames, passwords, and the like to only permit secure access to the PAS and other reporting. Other types of human interfaces may also be employed within the scope of the disclosure.

In illustrative examples, the person to be rehabilitated is an offender or ex-offender of a criminal justice system. For the offender or ex-offender, the PAS is indicative of an amount of pro-social group inclusion the offender or ex-offender has been able to achieve and maintain.

In another embodiment, a method for triaging rehabilitation of a person includes the step of providing the expert system as described herein, and according a numerical value to each of the plurality of data sets. The numerical values are indicative of the person's progress toward the rehabilitation. Using the expert system, the PAS is calculated with the numerical values. The person is permitted to review the PAS in a real-time manner using the human interface. It should be understood that, although offenders will be able to view their score, such access will be in a very limited manner (similar to the information one obtains on a credit score). Certain levels of in-depth data access will be reserved for intervention/supervision personnel who need to use data that contributed to the overall score for rehabilitation purposes.

The numerical values may be accorded to each of the plurality of data sets by a triage center in communication with the at least one memory via a web server. It should be appreciated that data sets that are inherently numerical may be accorded a same number as originally provided, and that non-numerical data sets may be accorded the numerical values based on a predetermined scale of progress towards rehabilitation (e.g., 0—no or below-average progress, 5—average progress, 10—above-average progress, etc.). One of ordinary skill in the art may select the specific methodology to be used for according numerical values to the various data sets, as desired.

The numerical value of each of the data sets may also be weighted depending on an importance of the data set to the rehabilitation of the person, and depending on an interrelationship of the data set with at least one of the other data sets, as established by confirmed research results. In a particular example, the processor in executing the instruction set may weight the numerical values and sum the weighted numerical values to calculate the PAS. A variety of means for weighting the numerical values, including selection of appropriate weights depending on interrelationships between different ones of the data sets, are contemplated and may be selected by a skilled artisan within the scope of the present disclosure.

In certain embodiments, the system and method provides rehabilitation plans that are derived from comparison of multiple data sources to current best-practices research. The rehabilitation plans are computer-generated, individualized plans that list offender deficits and specific rehabilitation steps necessary to remediate those deficits. The rehabilitation plans are not linked to any specific philosophy or ideology, but are instead objectively generated from proved best-practices linked to current research of successful rehabilitation techniques.

In particular embodiments, the system and method measures reintegration—the level to which someone is integrated into society in a pro-social manner—and specifically the amount of pro-social group inclusion the person has been able to achieve and maintain. Qualitative information is also measured through a methodology that is able to classify and assign a numerical value to the continent of anecdotal/narrative information. The level of spirituality that the person adheres to, which is not theologically determinant—meaning any belief in a higher power, is also quantified. Measurements of evidence based program performance, including a measuring the amount of structural compliance of a service/rehabilitation/intervention provided as compared to best-practice standards that have been proved to result in successful offender rehabilitation, are also made using the system and method.

In exemplary embodiments, the system and methods provides a score that is derived from six distinct sources of data. The score may then be compared to current recidivism and best-practices research. The six distinct sources of data include: 1) historical data—records of past behavior; 2) assessment data—identification of mental/emotional deficits through the use of proprietary and/or standardized tools; 3) behavioral data—attendance at rehabilitative interventions/functions/activities, etc.; 4) performance data—rated behavior during training, rehabilitation, work, etc.; 5) observational data—observed reactions/attitudes during training, rehabilitation, work, etc.; and 6) self-reported data—ratings regarding how pertinent/satisfactory training, rehabilitation, work, etc., are to the offender in question.

In illustrative embodiments, the method uses the system components, which contains inherent motivators, to help the offender seek and reinforce beneficial rehabilitation functions/behaviors. The method applies to any rehabilitation function/activity which requires an intervention, and then measures how rehabilitated an offender is at any given point in time. The method inter-correlates the multiple types of data, for example, as identified hereinabove, from multiple sources to derive the score. Material deviations between actual behavior and needed behavior for rehabilitation to occur is immediately reported in the system in the form of exception reporting—capacity of the expert system to identify elements of behavior which indicate subject/offender is at risk.

### DRAWINGS

The above, as well as other advantages of the present disclosure, will become readily apparent to those skilled in the art from the following detailed description, particularly when considered in the light of the drawings described hereafter.

FIG. 1 illustrates an overview of the triage system that generates an offender Personal Achievement Score (PAS), which is a real-time measurement of offender rehabilitative success;

FIG. 2 illustrates an online registration process, which allows intervention providers to gain access to the triage system and its outputs;

FIG. 3 illustrates a process used by the offender to gain access to the triage system for the purposes of data input and score reporting; and

FIG. 4 illustrates how the triage system functions to coordinate continuity of offender rehabilitation efforts.

### DETAILED DESCRIPTION OF THE INVENTION

The following description is merely exemplary in nature and is not intended to limit the present disclosure, application, or uses. It should also be understood that throughout the drawings, corresponding reference numerals indicate like or corresponding parts and features. In respect of the methods disclosed, the order of the steps presented is exemplary in nature, and thus, is not necessary or critical unless otherwise disclosed.

Although the system and method of the present disclosure are described herein below with respect to rehabilitation of an offender 10, it should be understood that the triage system also may be applied to persons in other rehabilitation settings including, but not limited to, medical, psychological, and educational systems. One of ordinary skill in the art may employ the triage system and method for other types of rehabilitation systems, as desired.

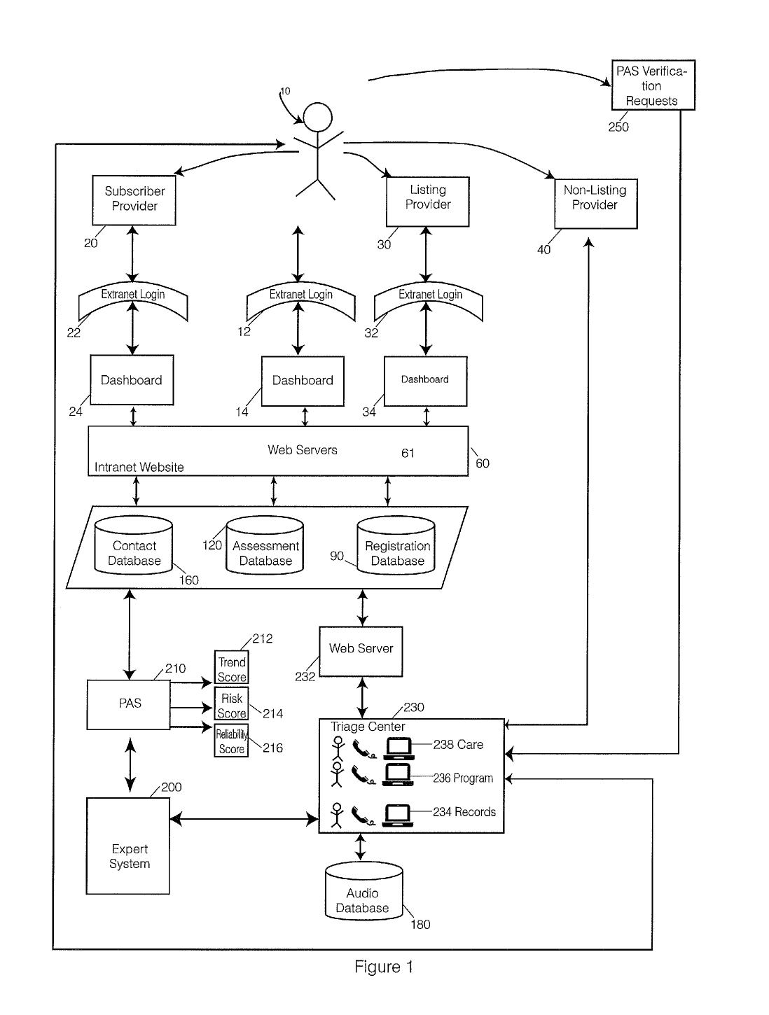

FIG. 1: Overview.

A schematic overview of a triage system that links a diversity of offender intervention providers 20, 30, 40 in order to measure in real-time the given degree of rehabilitation achieved by the offender 10 is shown in FIG. 1. Elements used in supporting and implementing the system can be connected through combinations of various forms of communications networks, for example the Internet, an intranet, an extranet, etc. Additional elements not shown in FIG. 1 can, and may be, included in such a system in order to best provide a unified platform from which to both give and receive reporting data regarding the rehabilitation progress of the offender 10.

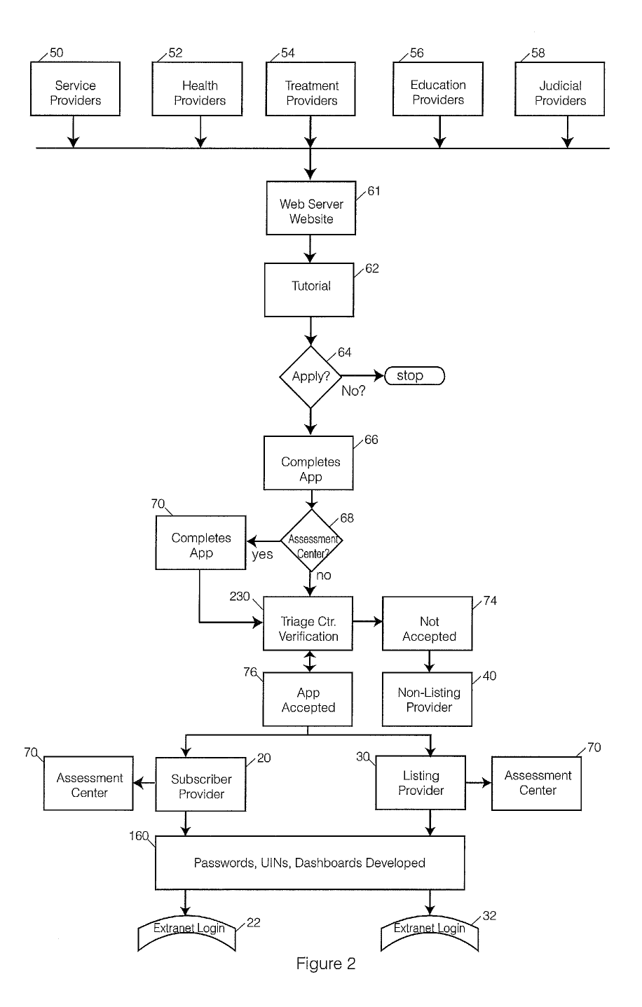

Access to the system will be accorded as a result of classifications of providers completing online applications, as shown in detail in FIG. 2.

Applicant providers will be assigned to different categories in terms of the level of record blocking security deemed most appropriate to the type of intervention they will offer to the offender 10. The possible categories which have been established would minimally include, but not necessarily be limited to:

Subscriber Providers 20—that due to the nature of the rehabilitation service they are providing would benefit from access to a specified area of an offender's collected assessment data (e.g., a substance abuse treatment organization would gain information from certain assessment results which would assist them in delivering care, etc.). Access to assessment data would be subject not only to the type of service provided, but also any pertinent legal restrictions, and as appropriate consent forms or service agreements would allow.

Listing Providers 30—that would desire to be listed as a possible intervention/rehabilitation resource, but due to the nature of the service they are providing would not by definition require, or would be legally restricted from access to the Assessment database.

Non-Listing Providers 40—that opt not to have their organization listed as a general intervention provider (e.g., are not desirous of/geared to having offenders systematically referred to their organization), but rather choose to report an isolated incidence of the offender 10 rehabilitation activity (e.g., the offender 10 is taking a class in a unique setting not specifically tailored for the offender population). In such a case, a special consent report form will be submitted directly to the Triage Center 230 through various means such as fax, email, regular mail, etc., for the purposes of submission of contact data. As nonlimiting examples, the non-listing provider 40 may include employers, credit bureaus, government entities, and insurance providers. Other types of non-listing providers 40 are also within the scope of the present disclosure.

Dashboards 14, 24, 34 providing access to real-time reporting will be personalized to the category of the intervention provider 20, 30, and to the offender 10. The dashboard 14, 24, 34 will afford various determined levels of data exchange between the offender 10, intervention provider 20, 30, and triage center 230.

Electronically submitted incoming and outgoing data will be collected and appropriately sorted and collated in three separate categories of databases 90, 120, 160 accessed through web servers 60.

Registration database 90—necessary information submitted in order to ultimately be given access to the system for the purpose of ultimately being listed as a potential intervention provider, and/or certified assessment center.

Assessment database 120—a distinct database which will be used to collect and store defined assessment battery submissions until completed by the offender 10. Upon completion the data will automatically forwarded to the expert system 200 for derivation of an initial offender 10 Personal Achievement Score (PAS) 210. Incomplete data will be stored for 12 months, allowing completion any time during that period by the offender 10. Thereafter any collected incomplete data under a specific offender 10 UIN (Unique Identifier Number) will be unattached to any offender 10 identifying information and used purely for purposes of system evaluation.

Contact database 160—a distinct database will be used to collect and store incoming data regarding offender 10 attendance, performance, etc., and as a platform for transmitting appropriate status reports to the intervention providers 20, 30 and the offender 10, as well as a continual real-time PAS 210.

Audio database 180—all audio contacts between triage center personnel 230 and outside sources, such as the intervention providers 20, 30, 40 and/or offender 10 will be automatically recorded and stored in this database. Delineated data, such as time of call, duration, frequency of contact with a specific offender 10, etc., will be forwarded to the expert system 200 for population of appropriate PAS fields 210.

Registration, assessment, and contact data which cannot be derived electronically, but are necessary for ultimate PAS validity, will be entered into the system by triage center personnel 230, which will include the submission of, but not necessarily be limited to:

Records analysts 234—will review and rank pertinent offender Department of Corrections (DOC) files, and other historical records data, in order to complete fields of the PAS 210 necessary to derive a valid score. It should be appreciated that the files and data to be reviewed may include all kinds of historical/behavioral records which have been developed/collated by all levels of intervention providers, and is not limited to DOC records. Other non-limiting examples of records for review and ranking include records from probation, parole, medical, etc. They will also receive, confirm, and rank supporting documentation submitted by the offender 10 and various intervention providers 20, 30, 40 which are pertinent to the population of PAS fields. Additionally, they will review all PAS score verification requests 250, from sources outside the triage system.

Program personnel 236—will review requests and submissions of registration information from intervention providers 20, 30, 40 seeking system inclusion. All approved requests will be assigned a level of record blocking security in terms of input/output of data, and any dashboard construction will reflect same.

Care managers 238—specifically assigned to the offender 10 will collect contact data in the form of benchmarking and information reporting, as well as inform appropriate intervention providers 20, 30, 40 of alerts from the expert system 200 which indicate the offender 10 requires special rehabilitation attention. Commensurately, intervention providers 20, 30, 40 will systematically submit attendance, performance, planning, and informational data regarding their rehabilitative action with the offender 10.

The expert system 200 will be fed, from the appropriate web servers, incoming data from the databases and sources outlined hereinabove. It will subsequently analyze the data and consistently publish and update every 24 hours, through the contact database 160, a discrete offender PAS 210 for all appropriate parties. Minimal levels of PAS reporting will include, but not necessarily be limited to:

PAS 210—the overall real-time achieved rehabilitation score populated from designated rankings derived in the expert system 200.

Trend score 212—a continuous measure of rehabilitation efforts for the life of the offender 10. It will graph the entire progress of the offender 10 from the establishment of a baseline PAS score 210 (derived at the time the offender 10 designates the score to be activated) and his/her progress throughout their course of rehabilitation, and their achievement of societal reintegration.

Risk score 214—a continuous measure of rehabilitative needs on the part of the offender 10 plotted in percentile ranking form. The baseline score used for continual charting will be derived from the collective data used to rank a specific offender 10 within the normal distribution of offenders 10 nationwide. Furthermore ranking order will determine the appropriate level of triage center/intervention provider contact recommended for that sector of the offender 10 population, in order to better insure successful rehabilitation.

Predictive reliability score 216—a continuous measure of the reliability of the PAS at any given time based on current level of collected data.

FIG. 2: Online Registration Process.

In order to be prepared to collect and submit data necessary to derive a valid PAS 210, multi-classifications of intervention providers 20, 30, 40 will first need to complete an online application which will allow them access to differing levels of data input/output from the expert system 200.

The classifications of intervention providers 20, 30, 40 that will attend to the offender 10, and both input data and receive data reports, will minimally include, but not be limited to: Service providers 50 (e.g., agencies/organizations that provide housing, clothing, transportation, food, etc); Health providers 52 (e.g., medical care, physical rehabilitation, etc.); Treatment providers 54 (e.g., substance abuse, mental health, marriage counseling, family counseling, etc.); Education providers 56 (literacy instruction, trades certifications, GED's, all forms of higher education degrees, etc.); and Judicial providers 58 (e.g., Probation/Parole offices, various government agencies dedicated to offender 10 reentry efforts, etc.).

Prospective intervention providers 20, 30, 40 will remotely access an Internet-based website 61 hosted on the web server 60 via a web browser. An introductory video tutorial 62 will describe the entire scoring system 210, such as security levels, provider reporting requirements and management, reporting capacities of the system, protocols for reporting submission, necessary consent forms, access protocols, etc. At the completion of the tutorial, the prospective intervention provider 20, 30, 40 will choose whether or not to continue with the registration process 64.

Prospective intervention providers 20, 30, 40 that decide to apply continue with the process by completing the mandatory fields on the registration form 66, and delineate whether or not they will also request to be simultaneously classified as a certified assessment center 68, thereby designating the offender 10 will be able to use their facility to complete any elements of a defined computer-based assessment battery.

An assigned assessment center classification will allow the organization so classified to assign an offender 10 a Unique Identifier Number (UIN) from the assessment database 120 that will further allow the offender 10 access to the defined computer-based assessment battery.

All incoming registration data is collated and sorted in the registration database 160, and forwarded for further account information verification (e.g., appropriate accreditations, business licenses, etc.), by designated triage center personnel 230. Those not passing threshold verification standards will be informed that they will automatically be classified as a non-listing provider 40 (data transfer capabilities will be limited to reporting offender 10 interaction via document submission directly to the triage center 230).

Accepted/accredited intervention providers 76 will be assigned levels of record blocking security based on their categorization of intervention provision. Those categories will minimally include, but not necessarily be limited to:

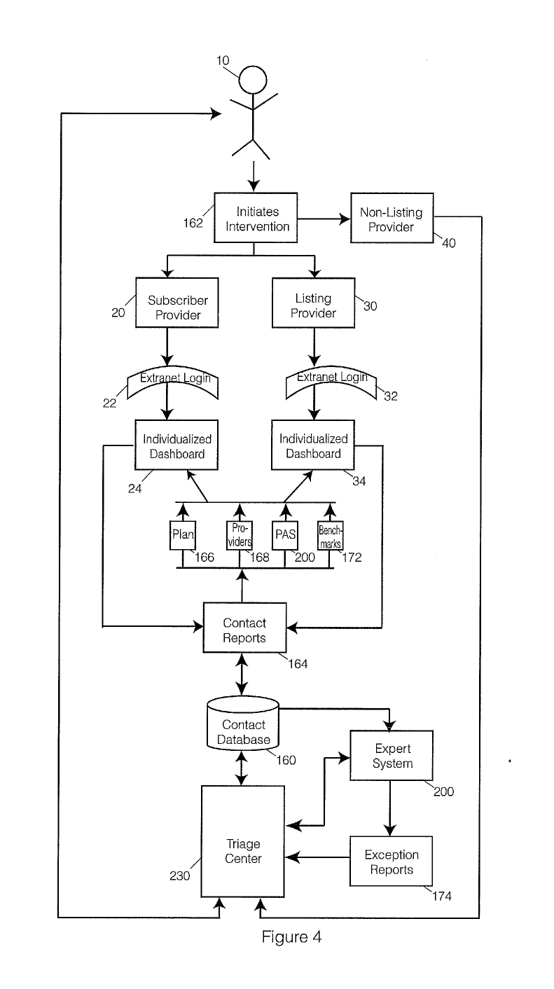

Subscriber provider 20—Rendered a provider password and UIN, and individualized dashboard for the purposes of inputting offender 10 data and receiving reports which will be determined by level of care, consent form allowance, appropriate legal guidelines, etc. This category of provider will also be listed as a possible source of matched intervention on a possible providers list 168, shown in FIG. 4.

Listing provider 30—Rendered a provider password and UIN for the purposes of inputting offender 10 data only, and providing a location for the offender 10 to have online access to complete any elements of the defined assessment battery (if they are also listed as a certified assessment center). This category of provider will also be listed as a possible source of matched intervention on the possible providers list in FIG. 4.

Category provider passwords, UINs, and dashboards will be developed out of the registration database 90 in preparation for activation.

Notification of provider password, UIN, and dashboard access will be forwarded to accepted intervention provider 20, 30, 40 registrants. The number of UINs assigned to any given provider will be determined by the number of people in the organization who will be responsible for submitting reporting data to the contact database 160, with appropriate levels of record blocking security attached to same.

Automated activation of access to dashboards 24, 34, and/or defined appropriate database 90, 120, 160 will be achieved upon the first usage of the provider password and UIN.

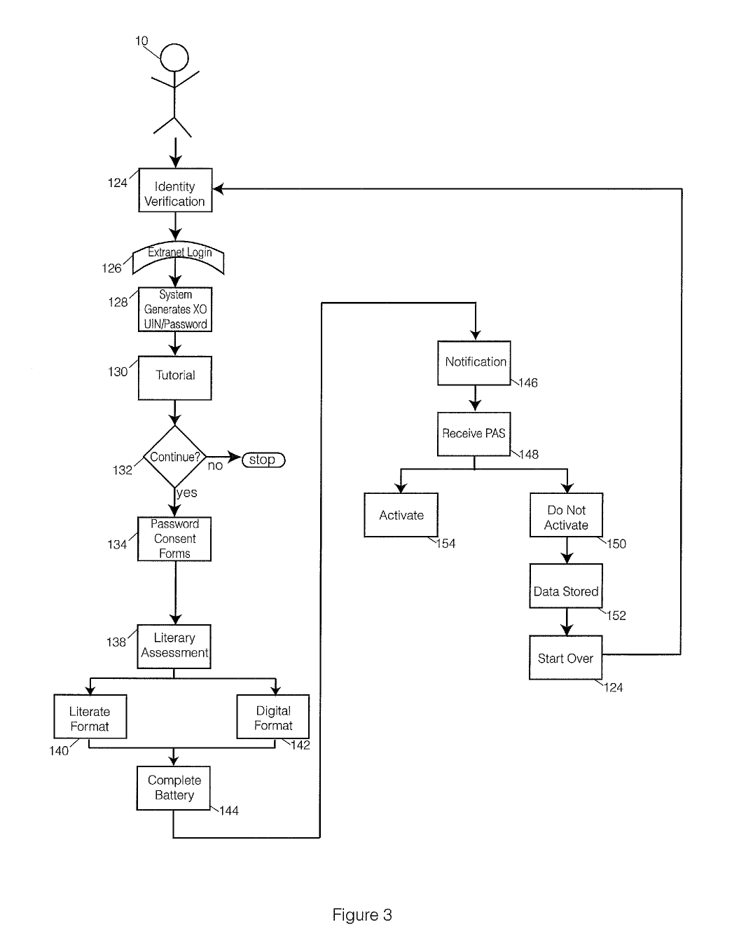

FIG. 3: Assessment Data Collection.

As shown in FIG. 3, an offender 10 wishing to take the defined assessment battery, or parts thereof, presents authorized identification at a certified assessment center 124. In other embodiments, the offender 10 may verify his or her identity through other means, including electronic or virtual means such as a username and/or password.

Assessment center personnel 230 with an assigned provider password and UIN access the system 126 on behalf of the offender 10.

Assessment center personnel 230 accesses the assessment database 120 and enter defined unique offender 10 information necessary to derive the following 128:

Temporary password—used to initially access the system and will mandatorily be required to be changed by the offender 10 before beginning their first assessment session for purposes of security

Permanent UIN—used for continual access to the individualized offender dashboard 14

Offender 10 accesses the system for the purposes of taking the defined assessment battery.

The offender 10 is required to view an introductory tutorial 130 which will minimally include, but not necessarily be limited to scoring 210 and dashboard 14 information, protocol for submitting documentation relating to rehabilitation efforts, triage center 230 and other contacts, etc.

Offenders 10 who opt to continue taking the battery 132 will be required to fill out the following prerequisites 134 prior to completing the battery:

Defining permanent password—delineates a password which is only known to the offender 10.

Consent forms digitally signed—allowing access to documentation, personal contacts, etc.

It should be noted that completion of the above will be necessary to gain access to the assessment battery.

Once the parameters are met, the offender 10 will be able to take the defined assessment battery, or any part thereof, starting with the literacy assessment 138. The literacy assessment 138 will determine whether or not the offender 10 will continue taking the remainder of the battery in a literate format 140 versus a digital format 142, whereby the digital format 142 will allow even offenders 10 whose test results indicate they are illiterate to take any defined assessments.

The offender 10 in question completes the battery 144. It should be noted that at any time during the completion of the battery, the offender 10 may opt to defer taking any remaining assessments until another time. Data will be stored in the assessment database 120 under the offender's UIN until the offender 10 indicates the assessment battery is completed to the offender's satisfaction.

When the offender 10 in question indicates they have completed the battery to the offender's satisfaction 146, any remaining assessment data, and the data which has been stored in the assessment database 120, will be sent to the expert system 200, and an initial PAS 210 immediately computed and reported 148 to the offender 10 in question. At that point the offender 10 will make a determination of whether they want to activate their score through choosing one of two options:

Do not activate 150—whereupon the data will be stored in the assessment database 120 for 12 months. After that time, if the offender 10 opts to activate their score they will be required to take the battery, or any parts thereof, from the beginning step 124. Otherwise, they will be able to activate their score at any time during the calendar year following their initial assessment session by accessing the system and giving permission for their score to be activated 154.

Activate 154—data will be permanently stored for access for the purposes of consistent and continual reporting to designated dashboards 24, 34 and the fulfillment of PAS reporting 210 to designated independent requesting sources 250.

Upon receipt of the order to activate, the assessment database 120 will create an individualized dashboard 14 for the offender 10 in question, which the offender 10 can use to view their score, gain information regarding potential intervention providers 20, 30, print necessary consent forms for document submission, provide benchmarks for designated intervention providers, communicate with triage center personnel 230, etc. The offender 10 can also print reports to submit to interested parties.

The activated score of an offender 10 will then be reported in real time to all appropriate dashboards 24, 34 which will minimally include, but not be limited to the dashboard 14 of the offender 10 and the dashboards 24, 34 of the designated intervention providers 20, 30.

FIG. 4: Reporting Data Collection.

As shown in FIG. 4, the offender 10 initiates various rehabilitation actions through attending 162 treatment/education sessions, and/or accessing services through local intervention providers 20, 30, 40.

The intervention providers 20, 30, 40, which are defined as being in the category of subscriber provider 20 and/or listing provider 40, use their provider password and UIN to log into the extranet 22, 32 and access their individualized dashboard 24, 34. Commensurately, Non-listing providers 40 send reporting documentation regarding rehabilitation efforts directly to the triage center 230 for input in the contact database 160.

Contact data from the intervention provider 20, 30 is entered into the contact database 160 via a status report field 164 on the provider's dashboard 24, 34. The data collected will minimally include, but not be limited to, attendance, performance, any alteration of treatment course, and continuity of care of the offender 10.

Outgoing reports to providers generated by the contact database 160, which will populate individualized provider dashboards 24, 34, will minimally include, but not be limited to:

Prioritized system recommended rehabilitation plan 166—generated by the expert system 200 and derived from the information gained in the assessment battery.

Possible provider list 168—generated by the expert system 200 that will match the capacities of providers accessible to the offender's location of residence to their rehabilitation needs. This list can be used by all classifications of intervention providers 20, 30 as a source of intervention referral for the offender 10, as well as directly to the offender in question.

PAS Score 210—current overall level of measurement of an offender's rehabilitative progress.

Benchmarks 172—offender 10 rating of current intervention provider activities, both collectively and in terms of how satisfied they are with the level of treatment/services they are receiving from a specific intervention provider 20, 30. This can be used by the provider 20, 30 in question as a source for continuous improvement modeling of interventions.

Exception reports 174 generated from the expert system 200 will be automatically sent to appropriate triage center personnel. Such reports will alert center personnel to any occurrences in the course of an offender's rehabilitation which have been ranked as requiring immediate attention.

Upon receipt of an exception report, triage center personnel 230 will determine the best course of action to take regarding notifying intervention providers 20, 30, 40 of any offender 10 situation which could interfere with the successful negotiation of their course of rehabilitation. Methods of notification could include, but not necessarily be limited to telephone calls, various methods of electronic correspondence, etc., both to appropriate intervention providers 20, 30, 40 as well as the offender 10 in question.

Continuous and real-time reporting of rehabilitation efforts on the part of the offender 10 and various intervention providers 20, 30, 40 will be maintained throughout the offender's 10 course of care and thereafter in terms of the offender's 10 decision to report ongoing rehabilitation implementation activities, such as attendance at AA meetings, promotions at work, etc.

Calculation of PAS.

The calculation of PAS by the system and method of the present disclosure may be conducted in a variety of ways, with the various data sets indicative of progress toward rehabilitation used to generate a single PAS number. The single PAS number is personalized to the offender 10, and is calculated from the data sets described hereinabove.

As described hereinabove, numerical values may be accorded to each of the plurality of data sets, based on a qualitative analysis of the data sets. It should be appreciated that data sets that are inherently numerical may be accorded a same number as originally provided, and that non-numerical data sets may be accorded the numerical values based on a predetermined scale of progress towards rehabilitation (e.g., 0—no or below-average progress, 5—average progress, 10—above-average progress, etc.). One of ordinary skill in the art may select the specific methodology to be used for according numerical values to the various data sets, as desired.

As shown in TABLE 1 and TABLE 2, the numerical value of each of the data sets may also be weighted depending on an importance of the data set to the rehabilitation of the person, and depending on an interrelationship of the data set with at least one of the other data sets.

TABLE 1
Offender #1: PAS Calculation Example

| | | | Weighted |
|---|---|---|---|
| Data Source | Numerical Value | Weight* | Numerical Value |
| Historical | 20 | 1 | 20 |
| Assessment | 50 | 1 | 50 |
| Behavioral | 20 | 1 | 20 |
| Performance | 50 | 1 | 50 |
| Observational | 20 | 1 | 20 |
| Self-Reported | 80 | 0.25 | 20 |
| | | PAS | 180 |

*Varies due to interaction with other data sources (e.g., low observational and behavioral result in lower weight for self-reported)

In TABLE 1, numerical values of a behavioral data set and an observational data set are interrelated with the numerical value associated with the self-reported data set for the offender 10. In view of the lower numerical values assigned to the behavioral data set and the observational data set, a weight of the numerical value for the self-reported data set is minimized. Accordingly, the resulting PAS for the offender 10 is also decreased.

TABLE 2
Offender #2: PAS Calculation Example

| | | | Weighted |
|---|---|---|---|
| Data Source | Numerical Value | Weight* | Numerical Value |
| Historical | 20 | 1 | 20 |
| Assessment | 50 | 1 | 50 |
| Behavioral | 70 | 1 | 70 |
| Performance | 50 | 1 | 50 |
| Observational | 70 | 1 | 70 |
| Self-Reported | 80 | 2 | 160 |
| | | PAS | 420 |

*Varies due to interaction with other data sources (e.g., high observational and behavioral result in higher weight for self-reported)

In TABLE 2, by way of contrast, numerical values of the behavioral data set and the observational data set are again interrelated with the numerical value associated with the self-reported data set for the offender 10. In view of the higher numerical values assigned to the behavioral data set and the observational data set, the weight of the numerical value for the self-reported data set is maximized. Accordingly, the resulting PAS for the offender 10 is also increased.

Advantageously, the method of calculating the PAS accounts for interrelationships between the various indicators of progress towards rehabilitation, and does not simply sum or otherwise combine the data sets without weighting of the data sets based upon these interrelationships, and against the research.

The examples in TABLE 1 and TABLE 2 are provided for illustration purposes only, and one of ordinary skill in the art should understand that the various numerical values assigned to the data sets (and also to subsets of the data sets) and interrelationships between data sets and subsets of the data sets that affect the weighting of the numerical values, may be selected as desired.

Alternate Implementations.

It should be appreciated that, although described hereinabove with respect to an offender 10 within or released from the criminal justice system, the system and method of the present disclosure is applicable to any field in which an intervention is necessary to achieve rehabilitation. This is distinct to self-improvement behaviors—for example a person who chooses to work out at a gym is engaging in self-improvement behavior, however the moment they decided to hire a personal trainer that would qualify as rehabilitation since they needed the intervention of the trainer to either learn something, refine the application of something learned, or provide the motivation which they lack to achieve desired rehabilitative goals.

The PAS is a real-time measure and report of the efficacy of rehabilitation efforts, processes, and outcomes, and it measures three levels of rehabilitation: amount of rehabilitation necessary; efficacy, efficiency, and potency of current rehabilitation activities; and maintenance of learned rehabilitative behavior.

Advantageously, the system and method enables a triage of rehabilitation functions, and has the capacity to provide coordination of an unlimited number of diverse providers of rehabilitation services/interventions. By so doing, the system and method insures continuity of care—prevents losing the offender through the “cracks” of service delivery since they need to see multiple and diverse service providers in order to achieve full rehabilitation (e.g., mental, emotional, physical, occupational, etc.) and need assistance coordinating same. The system and method also provides elongated access to service for the offender (tracks and refers to services throughout the life of the offender)—since once an offender, always an offender and therefore possibly in need of intervention, service referral, or verification of rehabilitation throughout their lifetime.

This advantage to the system and method of the disclosure holds true for any population which has been rehabilitated—for example, alcoholics are always vulnerable to going back to drinking even if they have been alcohol free for decades, etc. This capacity to bring the offender back into the service cycle (along with the exception reporting mentioned above) actually helps/contributes to reducing recidivism—it is a case where the method of measurement itself contributes to the successful outcome which is desired as the ultimate goal of the interventions it is measuring.

It is also surprisingly found that the system and method can provide a universal outcome measure of rehabilitation, i.e., the PAS. The single PAS which will hold meaning for multiple sources of rehabilitation regardless of their area of specialty—e.g., rating will have meaning (e.g., very high, high, moderate, low, very low in terms of how rehabilitated is a subject). The system and method allows for continuous/continual improvement monitoring of all levels of programming (a form of program/intervention evaluation). In relation to continual improvement, it measures general processes of the organization as a whole, e.g., whether a chosen methodology is resulting in rehabilitation as a whole—measured as a result of comparison to established best-practices of the industry in question. In relation to continuous improvement, it measures a subset of continual improvement which measures a specific process of an organization—e.g., whether a given approach used by a rehabilitation (a/k/a service provider) results in specific treatment goals being achieved (e.g., how one element of substance abuse training is contributing to desistance).

Rehabilitation plans generated by the system and method of the disclosure delineate the sequential treatment necessary for successful rehabilitation through the provision of an individualized prioritized list of deficits and an individualized prioritized list of rehabilitative goals which need to be accomplished in order to achieve successful rehabilitation for the person in question. The rehabilitation plans are holistic, and objective in that they are not tied to any predisposed treatment ideology/philosophy but instead determined by best-practice outcomes as delineated by current rehabilitation research, and provide a complete picture of remediation needed in mental, emotional, physical, occupational areas, etc.

While certain representative embodiments and details have been shown for purposes of illustrating the invention, it will be apparent to those skilled in the art that various changes may be made without departing from the scope of the disclosure, which is further described in the following appended claims.

What is claimed is:

1. A system for triaging rehabilitation of a person, comprising:
an expert system including a processor for executing an instruction set for calculating a personal achievement score (PAS) indicative of progress toward rehabilitation, the PAS being a single number;
at least one memory in communication with the processor of the expert system, the at least one memory including at least one database containing a plurality of data sets relating to the rehabilitation of the person, each of the plurality of data sets accorded a numerical value indicative of the person's progress toward the rehabilitation, the numerical values used by the expert system to calculate the PAS; and
at least one human interface in communication with the processor and the at least one memory, the human interface permitting the person to view the PAS in a real-time manner.

2. The system of claim 1, wherein the at least one database includes an assessment database, a contact database, and a registration database.

3. The system of claim 2, wherein the assessment database includes historical data, assessment data, behavior data, performance data, observational data, self-reported data, research data, and rehabilitation plan data, the rehabilitation plan data including proved elements of remediation outlined in individualized prioritized plan format, each of the historical data, assessment data, behavior data, performance data, observational data, self-reported data, research data, and rehabilitation plan data used to calculate the PAS.

4. The system of claim 1, wherein the processor of the expert system further executes instructions for generating a trend score, a risk score, and a reliability score, the trend score being a continuous measure of rehabilitation efforts over a time period relative to a baseline PAS initially calculated for the person, the risk score being a continuous measure of rehabilitative needs on the part of the person plotted in percentile ranking format and derived from the PAS of the person relative to the normal PAS distribution for a population of persons stored in the at least one memory, and the reliability score being a continuous measure of the reliability of the PAS at any given time based on current level of collected data.

5. The system of claim 1, further including a triage center computer in communication with the at least one memory via a web server, the triage center assigning the numerical value to at least one of the plurality of data sets relating to rehabilitation of the person.

6. The system of claim 5, wherein the at least one memory further includes an audio database in communication with the triage center, all audio contacts between the triage center and the person, and all audio contacts between the triage center and an intervention provider recorded and stored in the audio database.

7. The system of claim 1, wherein the at least one human interface is in communication with the at least one memory via a web server, the at least one human interface providing secure access to the PAS by at least one of an intervention provider and the person.

8. The system of claim 1, wherein the person is an offender or ex-offender of a criminal justice system.

9. The system of claim 8, wherein the PAS is indicative of an amount of pro-social group inclusion the offender or ex-offender has been able to achieve and maintain.

10. The system of claim 1, wherein the numerical value of each of the data sets is weighted depending on an importance of the data set to the rehabilitation of the person and against current rehabilitation research, and depending on an interrelationship of the data set with at least one of the other data sets.

11. The system of claim 10, wherein the processor in executing the instruction set weights the numerical values and sums the weighted numerical values to calculate the PAS.

12. The system of claim 1, wherein the human interface includes a dashboard on a visual display.

13. A method for triaging rehabilitation of a person, the method comprising the steps of:
providing an expert system including a processor for executing an instruction set for calculating a personal achievement score (PAS) indicative of progress toward rehabilitation, the PAS being a single number, at least one memory in communication with the processor of the expert system, the at least one memory including at least one database containing a plurality of data sets relating to the rehabilitation of the person, and at least one human interface in communication with the processor and the at least one memory;
according a numerical value to each of the plurality of data sets, the numerical value indicative of the person's progress toward the rehabilitation;
using the expert system, calculating the PAS using the numerical values; and
permitting the person to review the PAS in a real-time manner using the human interface.

14. The method of claim 13, wherein the numerical values are accorded to each of the plurality of data sets by a triage center in communication with the at least one memory via a web server.

15. The method of claim 13, wherein the numerical value of each of the data sets is weighted depending on an importance of the data set to the rehabilitation of the person, and depending on an interrelationship of the data set with at least one of the other data sets.

16. The method of claim 13, wherein the processor in executing the instruction set weights the numerical values and sums the weighted numerical values to calculate the PAS.

17. The method of claim 13, wherein the plurality of data sets includes historical data, assessment data, behavior data, performance data, observational data, and self-reported data, and each of the historical data, assessment data, behavior data, performance data, observational data, and self-reported data is used to calculate the PAS.

18. The method of claim 13, wherein the person is an offender or ex-offender of a criminal justice system.

19. The method of claim 18, wherein the PAS is indicative of an amount of pro-social group inclusion the offender or ex-offender has been able to achieve and maintain.

20. A system for triaging rehabilitation of an offender or ex-offender, comprising:
an expert system including a processor for executing an instruction set for calculating an offender or ex-offender personal achievement score (PAS) indicative of progress toward rehabilitation, the PAS being a single number, wherein the PAS is indicative of an amount of pro-social group inclusion the offender or ex-offender has been able to achieve and maintain;
at least one memory in communication with the processor of the expert system, the at least one memory including at least one database containing a plurality of data sets relating to the rehabilitation of the offender or ex-offender, each of the plurality of data sets accorded a numerical value indicative of the offender or ex-offender's progress toward the rehabilitation, the numerical values used by the expert system to calculate the PAS, wherein the at least one database includes an assessment database, a contact database, and a registration database, wherein the assessment database includes historical data, assessment data, behavior data, performance data, observational data, and self-reported data, each of the historical data, assessment data, behavior data, performance data, observational data, and self-reported data used to calculate the PAS, wherein the processor of the expert system further executes instruction for generating a trend score, a risk score, and a reliability score, the trend score being a continuous measure of rehabilitation efforts over a time period relative to a baseline PAS initially calculated for the offender or ex-offender, the risk score being a continuous measure of rehabilitative needs on the part of the offender or ex-offender plotted in percentile ranking format and derived from the PAS of the offender or ex-offender relative to the normal PAS distribution for a population of offender or ex-offenders stored in the at least one memory, and the reliability score being a continuous measure of the reliability of the PAS at any given time based on current level of collected data, wherein the at least one memory further includes an audio database in communication with the triage center, all audio contacts between the triage center and the offender or ex-offender, and all audio contacts between the triage center and an intervention provider recorded and stored in the audio database;
a triage center computer in communication with the at least one memory via a web server, the triage center assigning the numerical value to at least one of the plurality of data sets relating to rehabilitation of the offender or ex-offender; and
at least one dashboard in communication with the processor and the at least one memory, the dashboard permitting the offender or ex-offender to view the PAS in a real-time manner, wherein the at least one dashboard is in communication with the at least one memory via a web server, the at least one dashboard providing secure access to the PAS by at least one of an intervention provider and the offender or ex-offender.
